(19) United States
(12) Patent Application Publication
(10) Pub. No.: US 2006/0024413 A1
(43) Pub. Date: Feb. 2, 2006

(54) Preparation of pumpable, edible composition using electrodialysis

(76) Inventor: Colin Crowley, Wheeling, IL (US)

Correspondence Address: KRAFT / FETF, 120 S. LASALLE STREET, SUITE 1600, CHICAGO, IL, 60603-3406, US

(21) Appl. No.: 11/209,226

(22) Filed: Aug. 23, 2005

Related U.S. Application Data
(63) Continuation-in-part of application No. 10/956,907, filed on Oct. 1, 2004.
Application No. 10/956,907 is a continuation-in-part of application No. 10/784,404, filed on Feb. 23, 2004.
Application No. 10/956,907 is a continuation-in-part of application No. 10/784,699, filed on Feb. 23, 2004.
Application No. 10/956,907 is a continuation-in-part of application No. 10/941,578, filed on Sep. 15, 2004.

(51) Int. Cl. A23B 4/20

(52) U.S. Cl. 426/326

(57) ABSTRACT

The present invention is directed to methods for acidifying aqueous pumpable edible compositions (PECs) directly using membrane electrodialysis. The pH of the pumpable edible compositions are lowered by at least about 0.5 pH unit. The acidified pumpable edible compositions have increased sourness and/or improved stability.

The present application is a continuation-in-part application of U.S. application Ser. No. 10/956,907 (Docket 77146), filed Oct. 1, 2004, which is a continuation-in-part application of U.S. patent application Ser. Nos. 10/784,404 and 10/784,699 both filed Feb. 23, 2004 and of U.S. patent application Ser. No. 10/941,578 (Docket 77039), filed Sep. 15, 2004), all of which are hereby incorporated by reference. Co-pending application serial number (Docket 77218) is also incorporated herein by reference.

The present invention is directed to methods for acidifying aqueous pumpable edible compositions (PECs) using membrane electrodialysis. The electrodialysis methods and electrodialyzed compositions are effective for lowering the pH of PECs for various purpose including increased sourness, inactivation of enzymes and enhanced microbiological stability.

### BACKGROUND

Food processing often requires pH adjustments to obtain desired product characteristics or stabilities. The direct addition of food acidulants (such as lactic acid, vinegar) inevitably leads to significant (often negative) alterations in taste and/or additional ingredient cost.

One alternative to adding food acidulants to foods or is to use acidic compositions generated by electrolysis and/or electrodialysis. Electrodialysis (ED) is used in connection with the separation of dissolved salts or other naturally occurring impurities from one aqueous solution to another aqueous solution. The separation of these dissolved salts or other impurities results from ion migration through semi-permeable, ion-selective membranes under the influence of an applied electric field that is established between a cathode (negative potential electrode) and an anode (positive potential electrode). The membranes may be selective for monovalent or multivalent ions depending on whether separation is desired between monovalent or multivalent cations and/or anions. The separation process results in a salt or impurity concentrated stream (known as a concentrate or brine) and in a salt or impurity depleted stream (known as a diluate). The concentrate and diluate streams flow in solution compartments in the electrodialysis apparatus that are disposed between the anode and cathode and that are separated by alternating cation and anion selective membranes. The outer most compartments adjacent the anode and cathode electrodes have a recirculating electrode-rinse solution flowing therethrough to maintain the cathode and anode electrodes clean. Using the same principle and processing method, another alternative is to acidify a PEC directly using electrodialysis. Applicable PECs include, but are not limited to, edible raw materials or ingredients, semi-processed products, and/or finished food products. Attempts have been documented to reduce the acidity of PEC such as plant juices or extracts (e.g. coffee and tea) and their concentrates through partial removal of natural occurring acids (e.g. citric, malic, tartaric, lactic, etc.) using an anion permeable membrane in an electrodialysis treatment (U.S. Pat. No. 3,369,906, U.S. Pat. No. 3,369,906 and EP 0049497B1).

### SUMMARY

The present invention is broadly directed to methods for acidifying any pumpable edible compositions (PECs) by direct membrane electrodialysis using at least one bipolar membrane and one ion-specific (cation or anion) membrane. The present invention provides a process that increases (not reduces) the acidity and retains (not removes) natural occurring acids of a PEC using electrodialysis process, particularly in combination with the use of bipolar membrane. Using the method pf present invention, the resulting PEC has a pH at least about 0.5 lower than the untreated starting PEC. Lowered pH enables (1) increased sourness, (2) enzyme related stability and (3) microbiological stability. The pH of treated PECs can be as low as 0.5, normally ranging from 1.0 to 5.0. The inventive ED process is efficient and applicable in treating nearly any pumpable edible fluids (i.e. PECS) of varying solid content as long as fouling of the membrane, interfering of flow by the particles in PEC and coagulation (of protein) can be controlled or prevented. Treatable PECs may include, but are not limited to, plant juices (e.g. fruit and vegetables juices, herb drinks, coffee, tea, and the like) and their extracts and/or concentrates, liquid dairy compositions (milk, cheese whey, whey, and the like) and their concentrates, protein compositions, syrups, soy derivatives, dressings, sauces, broths, batters, gravies, toppings, dips and spreads. PECs must be in form of a pumpable fluid, but can be in different physical or microstructural forms including simple aqueous solutions, suspensions (with dispersed particles), emulsions (with oil droplets) and mixtures thereof. Clarified aqueous solutions are most preferred.

In one aspect, a method is provided for preparing an acidified aqueous plant juice, extract, or concentrate by adjusting the pH of the aqueous plant juice, extract, or concentrate with electrodialysis to a pH of less than about 3, in another aspect, a pH in the range of about 1.0 to about 2.0. Examples of juices which may be processed using membrane electrodialysis include, fruit juices, vegetable juices, herb drinks, coffee, tea, and the like.

In one embodiment of the invention, a PEC is selected from fruit juice concentrates to prepare acidified juice concentrate. The method includes preparing an aqueous juice concentrate and adjusting the pH of the aqueous juice concentrate with electrodialysis to a pH of less than about 3, in another aspect, a pH in the range of about 1.0 to about 2.0. Examples of fruit juices which may be processed using membrane electrodialysis may include apple, citrus, passion fruit, pineapple, guava, berry, grape, melon, and the like juices as well as mixture thereof. Fruit juices which may be processed using membrane electrodialysis may come from fruits or fruit juice derivatives including single strength juice, clarified juice, nectar, juice concentrate, extract, puree, and mixtures thereof.

In another aspect, a method is provided for preparing syrup composition. The method includes preparing syrup and adjusting the pH of the syrup with electrodialysis to a pH of less than about 3.0, in another aspect, a pH in the range of about 1.0 to about 2.0. Examples of syrup composition which may be processed using membrane electrodialysis include corn syrup, high fructose syrup, high maltose syrup, glucose syrup, maple syrup, honey, and the like as well as mixtures thereof.

In another aspect, a method is provided for preparing an acidified protein composition. The method includes preparing an aqueous protein concentrate and adjusting the pH of the aqueous protein concentrate with electrodialysis to a pH of less than about 5.0, in another aspect, a pH in the range of about 3.0 to about 4.0. Examples of protein composition which may be processed using membrane electrodialysis are sourced from the group comprising dairy protein and derivatives, egg protein and derivatives, soy protein and derivatives, and the like.

Yet in another aspect, a method is provided for preparing PECs in form of semi processed or finished food products. The method includes, for example, preparing a salad dressing excluding normal acidulents (vinegar) and adjusting the pH of the dressing with electrodialysis to a pH of less than about 3.8, in another aspect, a pH in the range of about 2.5 to about 3.5. Examples of salad dressings which may be processed using membrane electrodialysis include Ranch, Catalina, thousand island (without relish), Italian (without oil, spices and herbs), and the like. Other PECs in form of semi processed or finished food products may also be similarly processed. Such PECs which may be processed using membrane electrodialysis include beverage, broth, sauce, batter, gravy, topping, dip, spread and the like.

### BRIEF DESCRIPTION OF THE DRAWINGS

FIG. 1 is one example of a membrane electrodialysis system for decreasing pH.

FIG. 2 is another example of a membrane electrodialysis system for decreasing pH.

### DETAILED DESCRIPTION

An aqueous pumpable, edible composition (PEC) may be used as a feed stream and processed using membrane electrodialysis to form an acidified PEC. In another aspect, membrane electrodialysis used may include at least one bipolar membrane and one ion-specific (cation or anion) membrane.

Pumpable Edible Composition (PEC)

Pumpable fluids of diverse origins and compositions may be used in the present invention. To ensure pumpability, the viscosity of a PEC is typically less than about 700 Pas.S, preferably less than about 300 Pas.S. For PEC with high level of acid-coagulatable food polymers (e.g., casein), large particulates and/or oil/ fat droplets, a preferred pretreatment of PEC (e.g., centrifugation, filtering) known to the experienced practitioners of ED or membrane filtration is used to remove as much insoluble material and particultates as possible from the PEC feed stream prior to the ED process. Precaution must also be taken to prevent phase transition (e.g., isoelectric precipitation of certain proteins) of pH sensitive food polymers (e.g., casein), if the pH change during ED process will approach or cross the isoelectric point of the food polymers. These precautions ensure an efficient ED process by maintaining membrane cleanness and proper flow property of PEC in process. If desired, removed insolubles may be added back to PEC after membrane electrodialysis process.

An aqueous feed solution for ED treatment should have a total cation concentration of at least about 0.0001N which is effective for providing an initial conductivity of about 0.1 mS/cm. Most PECs are rich in electrolytes which may be readily used for the membrane electrodialysis process without addition of salt, acid or base. PEC which can be processed with memebrane electrodialysis may be derived from any edible food origins including plant and animal and the mixture thereof.

The use of membrane electrodialysis provides a method for adjusting pH without the addition of acid or base. As such, salts and precipitates that may form with the addition of acids and bases are not formed and their removal is not required.

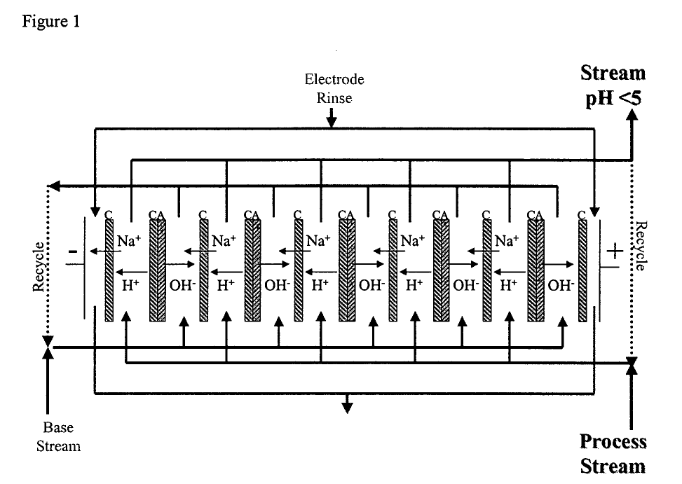

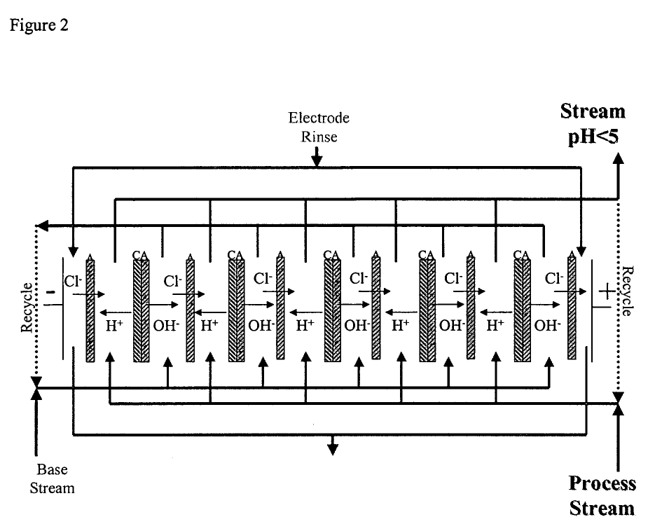

In accordance with one aspect, a juice concentrate is contacted with the ion-selective membranes. The juice composition may be processed in a batch mode, semi-continuous mode, or continuous mode. An electrical potential is applied across the anode and cathode for a time effective for providing compositions with the desired pH and ion concentrations. Processing times in a batch mode and flow rates in a semi-continuous mode or continuous mode are a function of the number of ion-selective membranes that are used and the amount of electrical potential applied. Hence, the resulting composition can be monitored and further processed until a desired pH is achieved. Alternative membrane configurations are provided in FIGS. 1 and 2. Membrane configuration can be varied.

Insoluble materials may be removed before or after pH adjustment. Any conventional technique (e.g., filtration, decantation, centrifugation, and the like) can be used. Preferably, the insoluble material is removed by centrifugation. Commercial available continuous centrifugation units are ideally suited for this separation in a semi-batch or continuous type operation. When pH adjustment results in formation of insoluble materials, those materials may be removed with removal techniques (e.g., centrifugation).

In one aspect, PEC which may be processed using membrane electrodialysis may also include vegetable juices, including extracts and concentrates. The method includes preparing an aqueous vegetable juice and adjusting the pH of the aqueous vegetable juice with electrodialysis to a pH of less than about 5, in another aspect, a pH in the range of about 3.0 to about 4.0. Examples of vegetable juices which may be processed using membrane electrodialysis may include carrot juice, tomato juice, celery juice, pepper juice, onion juice, garlic juice, and the like as well as mixtures thereof. Vegetable juices which may be processed using membrane electrodialysis may come from vegetables or vegetable juice derivatives including single strength juice, juice concentrate, nectar, extract, puree, paste and the mixture thereof.

In another aspect, PECs which may be processed using membrane electrodialysis may also include various edible extracts particularly plant extracts. The method includes preparing an aqueous extract and adjusting the pH of the aqueous extract with electrodialysis to a pH of less than about 5.0, in another aspect, a pH in the range of about 2.0 to about 4.0. Examples of extracts which may be processed using membrane electrodialysis may include extracts from herbs, tea, coffee, and the like. Edible plant extracts which may be processed using membrane electrodialysis may include single strength extract, concentrate, puree, paste, and mixtures thereof.

In one aspect, a method is provided for preparing syrup compositions. The method includes preparing the syrup composition and adjusting the pH of the syrup composition with electrodialysis to a pH of less than about 3.0, in another aspect, a pH in the range of about 1.0 to about 2.0. Examples of syrup compositions which may be processed using membrane electrodialysis include corn syrup, high fructose syrup, high maltose syrup, glucose syrup, maple syrup, honey, and the like.

In another aspect, a method is provided for preparing acidified aqueous protein compositions or concentrates. The method includes preparing an aqueous protein composition or concentrate and adjusting the pH of the aqueous protein composition or concentrate with electrodialysis to a pH of less than about 5.0, in another aspect, a pH in the range of about 3.0 to about 4.0. Examples of protein compositions which may be processed using membrane electrodialysis are sourced from dairy proteins (including whey protein), egg proteins, soy proteins, and the like.

Yet in another aspect, a method is provided for preparing PECs in form of semi processed or finished food products. The method also includes preparing the semi processed or finished food products and adjusting the pH of the semi processed or finished food products with electrodialysis to a pH of less than about 5.0, in another aspect, a pH in the range of about 2.5 to about 4.5. Examples of semi processed or finished pumpable food products which may be processed using membrane electrodialysis include beverage, broth, sauce, batter, gravy, topping, dip, spread and the like. The method also includes preparing a fat free ranch dressing excluding normal acidulents (vinegar) and adjusting the pH of the dressing with electrodialysis to a pH of less than about 3.8, in another aspect, a pH in the range of about 2.5 to about 3.5. Examples of salad dressings which may be processed using membrane electrodialysis include Catalina, thousand island (without relish), Italian (without oil, spices and herbs), and the like.

Membrane Electrodialysis. Membrane electrodialysis process which may be suitable for acidifying PECs may include at least one bipolar membrane and one ion-specific (cation or anion) membrane. As shown in FIGS. 1 and 2, membrane electrodialysis may be conducted using multiple electrodialysis cells comprising a bipolar membrane and an anionic or cationic membrane. The membranes are disposed between a cathode and anode and subjected to an electrical field. The membranes form separate compartments and materials flowing through those compartments may be collected separately. An example of an electrodialysis apparatus containing ion-selective membranes is EUR6 (available from Eurodia Industrie, Wissous, France). Suitable membranes are available, for example, from Tokuyama (Japan). A bipolar membrane includes a cationic membrane and an anionic membrane joined together.

In accordance with one aspect, an aqueous solution (i.e., the PEC) is contacted with the ion-selective membranes. Aqueous solutions may be processed in a batch mode, semi-continuous mode, or continuous mode by flowing an aqueous solution over the ion-selective membranes. An electrical potential is applied across the anode and cathode for a time effective for providing an electrodialyzed solution with the desired pH and ion concentrations. Processing times in batch mode and flow rates in semi-continuous mode or continuous mode are a function of the number of ion-selective membranes that are used and the amount of electrical potential applied. Hence, resulting ED solutions can be monitored and further processed until a desired pH and ion concentration is achieved. Generally, an electrical potential of about 0.1 to about 10 volts is provided across the anode and cathode electrode in each cell.

As shown in FIGS. 1 and 2, the pH of the aqueous solution may be adjusted to lower pH by at least 0.5 pH units with the final pH in a range of about 0 to about 7 by contacting the aqueous solution with at least one, preferably a plurality of bipolar membranes that includes cationic membranes on both sides of the bipolar membrane. Materials from the compartments to the left of the bipolar membranes are collected for subsequent use. Materials collected from the compartments to the right of the bipolar membranes may be recirculated back through the membranes or circulated to a second membrane electrodialysis as many times as needed to provide an aqueous solution having a pH of about 0 to about 7, preferably, about 1 to about 5. Materials from the compartments to the left of the bipolar membranes may also be recirculated back through the membranes. Materials from the compartments adjacent to the anode and cathode may be recirculated back through the membranes.

### EXAMPLES

### Example 1

Three liters of apple juice concentrate (about 40% total solids) was acidified using a cation permeable membrane-bipolar membrane setup. Three liters of 0.1 M sodium chloride was used as a caustic electrode rinse. Three liters of 0.5 M sodium sulfate was used as the electrode rinse stream. An electric potential less than 6.1 V per chamber was maintained throughout the process. A current density of less than 200 A/m² was applied to lower the pH of the juice concentrate from 3.53 to 1.49. While acidified apple juice was used in preparing a beverage, less acidulant (e.g. citric acid) is required to give the same sour taste of a control containing un-acidified juice.

### Example 2

Three liters of whey protein concentrate (about 9% whey protein) was acidified using a cation permeable membrane-bipolar membrane setup. Three liters of 0.1 M sodium chloride was used as the caustic electrode rinse stream. Three liters of 0.5 M sodium sulfate was used as the electrode rinse stream. An electric potential less than 3.1 V per chamber was maintained throughout the process. A current density of less than 400 A/m² was applied to lower the pH of the whey protein concentrate from 6.36 to 3.30. The resulting acidified whey protein concentrate exhibited increased microbiological stability.

### Example 3

Three liters of an oil free ranch dressing formulation (about 17% total solids) was acidified using a cation permeable membrane-bipolar membrane setup. Three liters of 0.1 M sodium chloride was used as the caustic electrode rinse stream. Three liters of 0.5 M sodium sulfate was used as the electrode rinse stream. An electric potential less than 1.5 V per chamber was maintained throughout the process. A current density of less than 300 A/m² was applied to lower the pH of the ranch dressing from 4.48 to 3.48. The treated ranch dressing had normal flavor, texture and improved taste and was made shelf stable without vinegar addition.

### Example 4

Three liters of high fructose corn syrup (about 42% total solids 70 Brix) was acidified using a cation permeable membrane-bipolar membrane setup. Three liters of 0.1 M sodium chloride was used as the caustic electrode rinse stream. Three liters of 0.5 M sodium sulfate was used as the electrode rinse stream. An electric potential less than 3.1 V per chamber was maintained throughout the process. A current density of less than 100 A/m² was applied to lower the pH of the corn syrup from 3.59 to 1.64. While acidified syrup was used in preparing a beverage, less acidulant (e.g. citric acid) is required to give the same sour taste of a control containing un-acidified syrup.

What is claimed is:

1. A method for preparing an acidified aqueous pumpable edible composition, said method comprising:
preparing an aqueous pumpable edible composition;
treating the aqueous pumpable edible composition with electrodialysis to lower the pH of the aqueous pumpable edible composition at least 0.5 pH units and to form the acidified aqueous pumpable edible composition.

2. The method of claim 1 wherein the viscosity of the aqueous pumpable edible composition is less than about 700 Pas.S.

3. The method of claim 1 wherein the pH of the acidified aqueous pumpable, edible composition is lowered to a pH in the range of about 1 to about 5.

4. The method of claim 1 wherein the aqueous pumpable, edible composition is selected from the group consisting of plant juices and extracts, liquid dairy compositions, protein compositions, syrups, soy derivatives, dressings, sauces, broths, batters, gravies, toppings, dips, spreads and mixtures thereof.

5. The method of claim 1 wherein the aqueous pumpable, edible composition is selected from the group consisting of fruit juices, fruit extracts, vegetable juices, vegetable extracts, coffee, tea, and mixtures thereof.

6. The method of claim 1 wherein the aqueous pumpable, edible composition is a syrup selected from the group consisting of corn syrup, high fructose syrup, high maltose syrup, glucose syrup, maple syrup, honey, and mixtures thereof.

7. The method of claim 1 wherein the aqueous pumpable, edible composition is an aqueous protein composition wherein the protein in the aqueous protein composition is selected from the group consisting of dairy protein, egg protein, soy protein, and mixtures thereof.

8. A method for preparing an acidified juice comprising:
preparing an aqueous juice; and
adjusting the pH of the aqueous juice concentrate with electrodialysis to a pH of less than about 3.0 to form the acidified juice.

9. The method of claim 8 wherein the juice is selected from the group consisting of apple juice, citrus juice, passion fruit juice, pineapple juice, guava juice, berry juice grape juice, melon juice, and mixtures thereof.

10. The method of claim 8 wherein the pH is adjusted to a pH of about 1 to about 2.

11. The method of claim 8 wherein the aqueous juice is an aqueous juice concentrate, an aqueous juice extract, or a mixture thereof.

12. The method of claim 9 wherein the aqueous juice is an aqueous juice concentrate, an aqueous juice extract, or a mixture thereof.

13. The method of claim 10 wherein the aqueous juice is an aqueous juice concentrate, an aqueous juice extract, or a mixture thereof.
